(19) United States
(12) Patent Application Publication
(10) Pub. No.: US 2019/0144782 A1
(43) Pub. Date: May 16, 2019

(54) LIQUID LAUNDRY DETERGENT COMPOSITIONS

(71) Applicant: Conopco, Inc., d/b/a UNILEVER, Englewood Cliffs, NJ (US)

(72) Inventors: Julie Bennett, Merseyside (GB); Robert John Carswell, Merseyside (GB); Eva-Maria Reis-Walther, Ludwigshafen (DE); David Christopher Thorley, Merseyside (GB); Juergen Gert Tropsch, Ludwigshafen (DE); Holger Michael Tuerk, Ludwigshafen (DE)

(21) Appl. No.: 16/300,174

(22) PCT Filed: May 12, 2017
(86) PCT No.: PCT/EP2017/061506

§ 371 Date: Nov. 9, 2018

(30) Foreign Application Priority Data
May 17, 2016 (EP) 16169849.3

(51) Int. Cl. C11D 1/83; C11D 11/00; C11D 3/37; C11D 3/00; C11D 3/386; C11D 3/40; C11D 3/395; C11D 3/50

(52) U.S. Cl. CPC C11D 1/83; C11D 11/0017; C11D 3/3723; C11D 3/0036; C11D 1/72; C11D 3/38663; C11D 3/40; C11D 3/395; C11D 3/50; C11D 3/3715

(57) ABSTRACT

A liquid laundry composition comprising: (i) one or more anionic surfactants; and (ii) a non-ionic ethoxylated C₁₀ Guerbet alcohol surfactant with a degree of ethoxylation in the range of 1 to 10; wherein the total amount of anionic surfactant in the composition is in the range of 15 to 25 wt % of the total composition and the weight ratio of the total amount of anionic surfactant to the non-ionic ethoxylated C₁₀ Guerbet alcohol surfactant is in the range of 6:1 to 100:1. Use of a liquid laundry detergent composition including a non-ionic ethoxylated C₁₀ Guerbet alcohol surfactant with a degree of ethoxylation in the range of 1 to 10 for laundering textiles wherein increased foam is provided during a main wash step when compared to a composition having a comparable level of anionic surfactant and substantially no non-ionic ethoxylated C₁₀ Guerbet alcohol surfactant with a degree of ethoxylation in the range of 1 to 10.

The present invention relates to improved laundry liquid detergent compositions.

### TECHNICAL FIELD

This invention relates to liquid laundry detergent compositions comprising one or more anionic surfactants and a non-ionic ethoxylated C₁₀ Guerbet alcohol surfactant, and use of such compositions as a foam-enhanced laundry detergent.

### BACKGROUND

Foaming is an important aspect of the user's perception of cleaning ability in laundry detergents. There is a general consumer perception that foam volume indicates the cleaning ability of a laundry composition. Therefore, it is important to provide a sufficient foam from a laundry composition during use. In general, an increase in volume of foam provides a good perception with the consumer.

Laundry detergent compositions are typically added to the wash water and are required to foam in relatively dilute water conditions. The foaming ability of a composition depends on the mixture of components in the composition, and surfactants play an important role in the ability of a laundry composition to foam when in use. Typically, an increase in the amount of anionic surfactant in a composition will lead to an increase in foaming. However, an increase in anionic surfactant levels can lead to an increase in cost of the laundry detergent composition.

### SUMMARY OF THE INVENTION

It is an aim of the present invention to provide excellent foaming from a laundry composition during laundry cleaning.

In a first aspect, the present invention provides a liquid laundry composition comprising:
(i) one or more anionic surfactants; and
(ii) a non-ionic ethoxylated C₁₀ Guerbet alcohol surfactant with a degree of ethoxylation in the range of 1 to 10;

wherein the total amount of anionic surfactant in the composition is in the range of 15 to 25 wt % based on the total weight of the composition and the weight ratio of the total amount of anionic surfactant to the non-ionic ethoxylated C₁₀ Guerbet alcohol surfactant is in the range of 6:1 to 100:1.

The present inventors have surprisingly found that such a liquid laundry composition provides improved foaming ability when compared with liquid laundry detergent compositions with the same or similar surfactant levels, in particular when compared with liquid laundry detergent compositions with the same or similar anionic surfactant levels.

In a second aspect, the present invention provides use of a liquid laundry detergent composition according to the first aspect to launder textiles.

### DETAILED DESCRIPTION OF THE INVENTION

As used herein, the term “degree of ethoxylation” refers to the number of moles of ethylene oxide reacted with one mole of the C₁₀ Guerbet alcohol to produce the ethoxylated C₁₀ Guerbet alcohol surfactant. It should be recognised that a distribution of ethoxylated reaction products is normally obtained during ethoxylation of, for example, alcohols. Typically, the degree of ethoxylation may therefore be designated as the “average degree of ethoxylation”, namely the average number of moles of ethylene oxide unit per mole of ethoxylated product.

Amounts of components in the liquid laundry detergent are given as a percentage of weight based on the total weight of the composition, unless otherwise stated.

Anionic Surfactant

The composition of the present invention includes one or more anionic surfactants in an amount in the range of 15 to 25 wt % weight. Anionic surfactants suitable for use in liquid laundry detergents are known. In general, the anionic surfactant(s) may be chosen from the surfactants described “Surface Active Agents” Vol. 1, by 5 Schwartz & Perry, Interscience 1949, Vol. 2 by Schwartz, Perry & Berch, lnterscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Types of Anionic Surfactant

Suitable anionic surfactants which may be used are usually water soluble alkali metal salts of organic carboxylates, sulphates and sulphonates having alkyl radicals containing from about 8 to about 22 carbon atoms, the term alkyl being used to include the alkyl portion of higher acyl radicals. Non-limiting examples of anionic surfactants useful herein include: C₉-C₁₈ alkyl benzene sulphonates (LAS); C₁₀-C₂₀ primary, branched-chain and random alkyl sulphates (AS); C₁₀-C₁₈ secondary (2,3) alkyl sulphates; C₁₀-C₁₈ alkyl alkoxy sulphates (AEₓS) wherein preferably x is from 1-30; C₁₀-C₁₈ alkyl alkoxy carboxylates preferably comprising 1-5 ethoxy units; mid-chain branched alkyl sulphates as discussed in U.S. Pat. Nos. 6,020,303 and 6,060,443; mid-chain branched alkyl alkoxy sulphates as discussed in U.S. Pat. Nos. 6,008,181 and 6,020,303; modified alkylbenzene sulphonate (MLAS) as discussed in WO 99/05243, WO 99/05242, and WO 99/05244; methyl ester sulphonate (MES); and alpha olefin sulfonate (AOS).

The preferred anionic surfactants are sodium C₁₁ to C₁₅ alkyl benzene sulphonates, sodium C₈ to C₁₈ alcohol ether sulphates and sodium C₁₂ to C₁₈ alkyl sulphates. Also applicable are surfactants such as those described in EP-A-328 177 (Unilever), which show resistance to salting-out, the alkyl polyglycoside surfactants described in EP A 070 074, and alkyl monoglycosides.

In some embodiments, the composition includes a C₈ to C₁₈ alcohol ether sulphate as an anionic surfactant. The C₈-C₁₈ alcohol ether sulphate may be derived from a fatty alcohol, wherein at least 80 wt %, preferably at least 82 wt %, more preferably at least 85 wt %, most preferably at least 90 wt % of said fatty alcohol is linear. By linear, what is meant is that the fatty alcohol comprises a single backbone of carbon atoms, with no branches.

In some embodiments, C₈ to C₁₈ alcohol ether sulphates are the sole anionic surfactants in the composition. In other embodiments, C₉ to C₁₈ alkyl benzene sulphonates are the sole anionic surfactants in the composition

When the composition includes a C₈-C₁₈ alcohol ether sulphate, the degree of ethoxylation of the C₈-C₁₈ alcohol ether sulphate is typically an integer in the range of 1 to 5. In preferred embodiments, the degree of ethoxylation of the C₈-C₁₈ alcohol ether sulphate is 1, 2 or 3

In preferred embodiments, the composition includes sodium lauryl ether sulphate (also known as sodium dodecyl ether sulphate or SLES) as an anionic surfactant. In some embodiments, the degree of ethoxylation of SLES is 1, 2 or 3. In some embodiments, the degree of ethoxylation of SLES is 3. In other embodiments, the degree of ethoxylation of SLES is 2. In further embodiments, the degree of ethoxylation of SLES is 1.

Two or More Anionic Surfactants

In some embodiments, the composition includes two or more anionic surfactants. The composition may include a C₈-C₁₈ alcohol ether sulphate and one or more further anionic surfactant. The composition may include a C₉-C₁₈ alkyl benzene sulphonate and one or more further anionic surfactant. In some embodiments, the composition includes a C₈-C₁₈ alcohol ether sulphate and a C₉-C₁₈ alkyl benzene sulphonate.

In some embodiments, the composition includes a C₈-C₁₈ alcohol ether sulphate or a C₉-C₁₈ alkyl benzene sulphonate in a ratio of about 1:4 to 4:1 to other anionic surfactants (when present) in the composition. In preferred embodiments the composition includes a C₈-C₁₈ alcohol ether sulphate or a C₉-C₁₈ alkyl benzene sulphonate in a ratio of about 2:3 to 7:2 to other anionic surfactants (when present) in the composition. In some embodiments the composition includes a C₈-C₁₈ alcohol ether sulphate or a C₉-C₁₈ alkyl benzene sulphonate in a ratio of about 2:3 to 3:2 to other anionic surfactants (when present) in the composition. In other embodiments, the composition includes a C₈-C₁₈ alcohol ether sulphate or a C₉-C₁₈ alkyl benzene sulphonate in a ratio of about 5:2 to 7:2 to other anionic surfactants (when present) in the composition.

In preferred embodiments, the composition includes sodium lauryl ether sulphate (SLES) and one or more further anionic surfactants. In further embodiments, the composition includes sodium lauryl ether sulphate (SLES) and sodium dodecyl benzene sulphonate (NaLAS).

Amount of Anionic Surfactant

The anionic surfactant or surfactants are present in the composition in an amount in the range of 15 to 25 wt %. In some embodiments, the anionic surfactant or surfactants are present in the composition in an amount in the range of 18 to 24 wt %, preferably 19 to 22 wt %.

In some embodiments, the composition comprises 18 to 24 wt % of anionic surfactants, including 8 to 20 wt % of C₈-C₁₈ alcohol ether sulphate (preferably SLES) and 4 to 12 wt % of a C₉-C₁₈ alkyl benzene sulphonates (preferably sodium dodecyl benzene sulphonate).

The anionic surfactants of the present application are typically salts, for example alkali metal salts. The salts also may be organic, for example salts of triethanol amine (TEA) or monoethanol amine (MEA). However, any of the anionic surfactants of the present application may be included in the composition of the present invention in the acid form. For example, the composition may include a linear alkyl sulfonic acid as an anionic surfactant.

Non-Ionic Ethoxylated C₁₀ Guerbet Alcohol Surfactant

The compositions of the present invention include one or more a non-ionic ethoxylated C₁₀ Guerbet alcohol surfactants with a degree of ethoxylation in the range of 1 to 10 as a minor surfactant component. The non-ionic ethoxylated C₁₀ Guerbet surfactant or surfactants act as a foam boosting component. The total amount of a non-ionic ethoxylated C₁₀ Guerbet alcohol surfactant with a degree of ethoxylation in the range of 1 to 10 in the composition is in a weight ratio in the range of 1:6 to 1:100 with respect to the total amount of anionic surfactant in the composition.

Guerbet alcohols are known and well defined β-alkylated dimer alcohols. Typically, the non-ionic ethoxylated C₁₀ Guerbet alcohol surfactant with a degree of ethoxylation in the range of 1 to 10 is represented by formula (I):

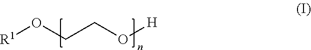

wherein R¹ is 2-propyl heptyl group and n represents the degree of ethoxylation and is an integer in the range of 1 to 10.

In some embodiments, the total amount of a non-ionic ethoxylated C₁₀ Guerbet alcohol surfactant with a degree of ethoxylation in the range of 1 to 10 included in the composition is in an amount in the range of 0.15 to 4 wt % based on the total weight of the composition. In further embodiments, the total amount of non-ionic ethoxylated C₁₀ Guerbet alcohol surfactant with a degree of ethoxylation in the range of 1 to 10 is in an amount in the range of 0.4 to 3.0 wt % based on the total weight of the composition, preferably 0.5 to 2.0 wt % based on the total weight of the composition.

In some embodiments, the non-ionic ethoxylated C₁₀ Guerbet alcohol surfactant has a degree of ethoxylation in the range of 3 to 10, 3 to 6, or 3 to 5.

Examples of C₁₀ Guerbet alcohol surfactant with a degree of ethoxylation of 3, 4 or 5 include Lutensol® XP-30, Lutensol® XP-40 and Lutensol® XP-50 from BASF Corporation. In some embodiments, the non-ionic ethoxylated C₁₀ Guerbet alcohol surfactant has a degree of ethoxylation of 4 or 5. In some embodiments, the C₁₀ Guerbet alcohol surfactant is a C₁₀ Guerbet alcohol surfactant with a degree of ethoxylation of 4.

The composition of the present invention may include two or more the non-ionic ethoxylated C₁₀ Guerbet alcohol surfactants with a degree of ethoxylation in the range of 1 to 10. In other words, the composition may include two or more non-ionic ethoxylated C₁₀ Guerbet alcohol surfactants, each surfactant having a different degree of ethoxylation in the range of 1 to 10.

When a mixture of non-ionic ethoxylated C₁₀ Guerbet alcohol surfactants with a degree of ethoxylation in the range of 1 to 10 is included in the composition, the total amount of the non-ionic ethoxylated C₁₀ Guerbet alcohol surfactant with a degree of ethoxylation in the range of 1 to 10 is within the specified ranges of the present invention, namely the total amount of the non-ionic ethoxylated C₁₀ Guerbet alcohol surfactant with a degree of ethoxylation in the range of 1 to 10 in the composition is in a weight ratio in the range of 1:6 to 1:100 with respect to the total amount of anionic surfactant in the composition.

Ratio of Anionic Surfactant to Non-Ionic Ethoxylated C₁₀ Guerbet Alcohol Surfactant with a Degree of Ethoxylation in the Range of 1 to 10

The weight ratio of total anionic surfactant to non-ionic ethoxylated C₁₀ Guerbet alcohol surfactant with a degree of ethoxylation in the range of 1 to 10 in the composition is typically in the range of 6:1 to 100:1. In other words, the non-ionic ethoxylated C₁₀ Guerbet alcohol surfactant with a degree of ethoxylation in the range of 1 to 10 is the minor surfactant component.

In some embodiments, the weight ratio of total anionic surfactant to non-ionic ethoxylated C₁₀ Guerbet alcohol surfactant with a degree of ethoxylation in the range of 1 to 10 in the composition is in the range 8:1 to 60:1. In other embodiments, the weight ratio of total anionic surfactant to non-ionic ethoxylated C₁₀ Guerbet alcohol surfactant in the composition is in the range of 12:1 to 50:1.

Other Surfactants

The composition may include other surfactants. These include additional non-ionic surfactants (other than non-ionic ethoxylated C₁₀ Guerbet alcohol surfactants with a degree of ethoxylation in the range of 1 to 10), cationic surfactants, amphoteric surfactants and/or zwitter-ionic surfactants.

In some embodiments, the composition is substantially free of or includes up to 5 wt % of one or more zwitter-ionic surfactants. Preferred examples of zwitter-ionic surfactants are C₁₂-C₁₄ dimethyl amine oxide and cocamidopropyl betaine (CAPB). In preferred embodiments the composition is substantially free of zwitter-ionic surfactant. In other embodiments, the composition optionally includes up to 3 wt %, preferably up to 1 wt % zwitter-ionic surfactant(s).

In some embodiments, the composition includes SLES with a degree of ethoxylation of 3 and up to 3 wt % of CAPB. In some embodiments, the composition also includes a salt, such as sodium chloride, when the composition includes CAPB.

Other Ingredients

Advantageously the composition comprises one or more polymers that are included in the composition, such as cleaning polymers, viscosity control polymers, structuring polymers and polymers for colour and garment care. Preferred polymers include ethoxylated polyethylene imine (available as Sokalan HP20 ex. BASF) and/or polyester soil release polymers. Preferably the detergent liquid further comprises at least 0.5 wt % ethoxylated polyethylene imine polymer. Most preferably it further comprises at least 0.2 wt % of polyester soil release polymers. More preferably the composition comprises at least 1 wt % of ethoxylated polyethylene imine.

The detergent composition may comprise an effective amount of at least one enzyme selected from the group comprising, pectate lyase, protease, amylase, cellulase, lipase, mannanase.

Enzyme Stabilizers:

Any enzyme present in the composition may be stabilized using conventional stabilizing agents, e.g., a polyol for example propylene glycol or glycerol, a sugar or sugar alcohol, lactic acid, boric acid, or a boric acid derivative, e.g., an aromatic borate ester, or a phenyl boronic acid derivative for example 4-formylphenyl boronic acid, and the composition may be formulated as described in e.g. WO 92/19709 and WO 92/19708.

Fluorescent Agents:

It may be advantageous to include fluorescer in the compositions. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.5 wt %.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra, Tinopal 5BMGX, and Blankophor (Trade Mark) HRH, and Pyrazoline compounds, e.g. Blankophor SN.

Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfoslyryl)biphenyl.

Bleach Catalyst:

Compositions may comprise a weight efficient bleach system. Such systems typically do not utilise the conventional percarbonate and bleach activator approach. An air bleach catalyst system is preferred. Suitable complexes and organic molecule (ligand) precursors for forming complexes are available to the skilled worker, for example, from: WO 98/39098; WO 98/39406, WO 97/48787, WO 00/29537; WO 00/52124, and WO00/60045, incorporated by reference. An example of a preferred catalyst is a transition metal complex of MeN4Py ligand (N,N-bis(pyridin-2-yl-methyl)-1-,1-bis(pyridin-2-yl)-1-aminoethane). Suitable bispidon catalyst materials and their action are described in WO02/48301. The bleach catalyst may be encapsulated to reduce interaction with other components of the liquid during storage.

Photobleaches may also be employed. A “photobleach” is any chemical species that forms a reactive bleaching species on exposure to sunlight, and preferably is not permanently consumed in the reaction. Preferred photo-bleaches include singlet oxygen photo-bleaches and radical photo-bleaches. Suitable singlet oxygen photo-bleaches may be selected from, water soluble phthalocyanine compounds, particularly metallated phthalocyanine compounds where the metal is Zn or Al—Z1 where Z1 is a halide, sulphate, nitrate, carboxylate, alkanolate or hydroxyl ion. Preferably the phthalocyanin has 1-4 SO₃X groups covalently bonded to it where X is an alkali metal or ammonium ion. Such compounds are described in WO2005/014769 (Ciba).

When present, the bleach catalyst is typically incorporated at a level of about 0.0001 to about 10 wt %, preferably about 0.001 to about 5 wt %.

Perfume

Compositions may further comprise a perfume. The inclusion of perfumes into laundry detergent compositions is known per se.

When the composition is used at very low levels of product dosage, it is advantageous to ensure that perfume is employed efficiently.

A particularly preferred way of ensuring that perfume is employed efficiently is to use an encapsulated perfume. Use of a perfume that is encapsulated reduces the amount of perfume vapour that is produced by the composition before it is diluted. This is important when the perfume concentration is increased to allow the amount of perfume per wash to be kept at a reasonably high level.

It is even more preferable that the perfume is not only encapsulated but also that the encapsulated perfume is provided with a deposition aid to increase the efficiency of perfume deposition and retention on fabrics. The deposition aid is preferably attached to the encapsulate by means of a covalent bond, entanglement or strong adsorption, preferably by a covalent bond or entanglement.

Where perfume encapsulates are included, it is advantageous to include a structuring system in the liquid detergent to enable stable suspension of the perfume encapsulates throughout the liquid detergent

Further Optional Ingredients:

The compositions may contain one or more other ingredients. Such ingredients include preservatives (e.g. bactericides), pH buffering agents, polyelectrolytes, anti-shrinking agents, anti-wrinkle agents, anti-oxidants, sunscreens, anti-corrosion agents, drape imparting agents, anti-static agents and ironing aids. The compositions may further comprise colorants, pearlisers and/or opacifiers, and shading dye.

Dye

Dyes are described in Color Chemistry Synthesis, Properties and Applications of Organic Dyes and Pigments, (H Zollinger, Wiley VCH, Zürich, 2003) and, Industrial Dyes Chemistry, Properties Applications. (K Hunger (ed), Wiley-VCH Weinheim 2003).

Dyes are soluble in the medium of application, in this case a laundry detergent liquid.

Dyes for use in liquid laundry detergents preferably have an extinction coefficient at the maximum absorption in the visible range (400 to 700 nm) of greater than 5000 L mol⁻¹ cm⁻¹, preferably greater than 10000 L mol⁻¹ cm⁻¹. Preferably the dyes are blue or violet in colour.

Preferred dye chromophores are azo, azine, anthraquinone, phthalocyanine and triphenylmethane.

Azo, anthraquinone, phthalocyanine and triphenylmethane dyes preferably carry a net anionic charged or are uncharged. Azine dyes preferably carry a net anionic or cationic charge.

Preferred non-shading dyes are selected are selected from blue dyes, most preferably anthraquinone dyes bearing sulphonate groups and triphenylmethane dye bearing sulphonate groups. Preferred compounds are acid blue 80, acid blue 1, acid blue 3; acid blue 5, acid blue 7, acid blue 9, acid blue 11, acid blue 13, acid blue 15, acid blue 17, acid blue 24, acid blue 34, acid blue 38, acid blue 75, acid blue 83, acid blue 91, acid blue 97, acid blue 93, acid blue 93:1, acid blue 97, acid blue 100, acid blue 103, acid blue 104, acid blue 108, acid blue 109, acid blue 110, and acid blue 213.

Blue or violet Shading dyes are most preferred. Shading dyes deposit to fabric during the wash or rinse step of the washing process providing a visible hue to the fabric. In this regard the dye gives a blue or violet colour to a white cloth with a hue angle of 240 to 345, more preferably 260 to 320, most preferably 270 to 300. The white cloth used in this test is bleached non-mercerised woven cotton sheeting.

The shading dye's fabric substantivity makes the neat contact staining worse.

Shading dyes are discussed in WO2005/003274, WO2006/032327 (Unilever), WO2006/032397 (Unilever), WO2006/045275 (Unilever), WO 2006/027086 (Unilever), WO2008/017570 (Unilever), WO 2008/141880 (Unilever), WO2009/132870 (Unilever), WO 2009/141173 (Unilever), WO 2010/099997 (Unilever), WO 2010/102861 (Unilever), WO 2010/148624 (Unilever), WO2008/087497 (P&G), WO2011/011799 (P&G), WO2012/054820 (P&G), WO2013/142495 (P&G) and WO2013/151970 (P&G).

A mixture of shading dyes may be used.

The shading dye chromophore is most preferably selected from mono-azo, bis-azo and azine.

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO2013/142495 and WO2008/087497. Preferred examples of thiophene dyes are shown below:

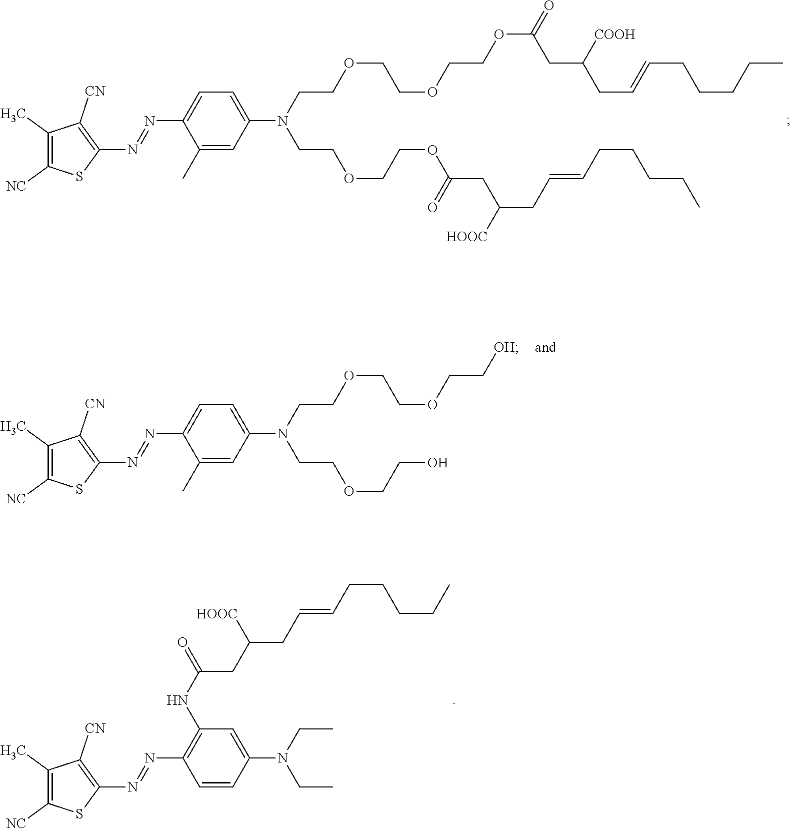

Bis-azo dyes are preferably sulphonated bis-azo dyes. Preferred examples of sulphonated bis-azo compounds are direct violet 7, direct violet 9, direct violet 11, direct violet 26, direct violet 31, direct violet 35, direct violet 40, direct violet 41, direct violet 51, direct violet 66, direct violet 99 and alkoxylated versions thereof.

Alkoxylated bis-azo dyes are discussed in WO2012/054058 and WO/2010/151906.

An example of an alkoxylated bis-azo dye is:

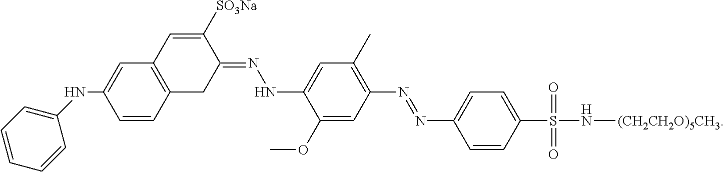

Azine dyes are preferably selected from sulphonated phenazine dyes and cationic phenazine dyes. Preferred examples are acid blue 98, acid violet 50, dye with CAS-No 72749-80-5, acid blue 59, and the phenazine dye selected from:

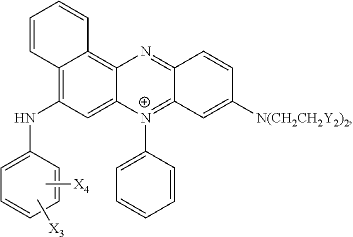

wherein:

X₃ is selected from: —H; —F; —CH₃; —C₂H₅; —OCH₃; and, —OC₂H₅;

X₄ is selected from: —H; —CH₃; —C₂H₅; —OCH₃; and, —OC₂H₅;

Y₂ is selected from: —OH; —OCH₂CH₂OH; —CH(OH)CH₂OH; —OC(O)CH₃; and, C(O)OCH₃.

The shading dye is present is present in the liquid composition in range from 0.0001 to 0.1 wt %. Depending upon the nature of the shading dye there are preferred ranges depending upon the efficacy of the shading dye which is dependent on class and particular efficacy within any particular class. As stated above the shading dye is a blue or violet shading dye.

Builders and Sequestrants

The detergent compositions may also optionally contain organic detergent builder or sequestrant material. Examples include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Italmatch Chemicals and alkanehydroxy phosphonates.

Other suitable organic builders include the higher molecular weight polymers and copolymers known to have builder properties. For example, such materials include appropriate polyacrylic acid, polymaleic acid, and polyacrylic/polymaleic acid copolymers and their salts, for example those sold by BASF under the name SOKALAN™.

If utilized, the organic builder materials may comprise from about 0.5% to 20 wt %, preferably from 1 wt % to 10 wt %, of the composition. The preferred builder level is less than 10 wt % and preferably less than 5 wt % of the composition. A preferred sequestrant is HEDP (1-Hydroxyethylidene-1,1,-diphosphonic acid), for example sold as Dequest 2010. Also suitable but less preferred as it gives inferior cleaning results is Dequest® 2066 (Diethylenetriamine penta(methylene phosphonic acid or Heptasodium DTPMP).

Buffers

The presence of some buffer is preferred for pH control; preferred buffers are MEA, and TEA. If present they are preferably used in the composition at levels of from 1 to 15 wt %.

External Structurants

The compositions may have their rheology modified by use of a material or materials that form a structuring network within the composition. Suitable structurants include hydrogenated castor oil, structuring polymers, microfibrous cellulose and natural based structurants for example citrus pulp fibre. Citrus pulp fibre is particularly preferred especially if lipase enzyme is included in the composition.

Visual Cues

The compositions may comprise visual cues of solid material that is not dissolved in the composition. Preferred visual cues are lamellar cues formed from polymer film and possibly comprising functional ingredients that may not be as stable if exposed to the alkaline liquid. Enzymes and bleach catalysts are examples of such ingredients. Also perfume, particularly microencapsulated perfume.

Packaging and Dosing

Preferably the liquids are supplied in multidose plastics packs with a top or bottom closure. A dosing measure may be supplied with the pack either as a part of the cap or as an integrated system.

The invention will now be further described with reference to the following non-limiting example.

### EXAMPLE

A liquid laundry detergent including around 20 wt % of an anionic surfactant and around 1 wt % of a non-ionic ethoxylated C₁₀ Guerbert alcohol surfactant with a degree of ethoxylation of 4 was compared in foaming tests against a control liquid laundry detergent including around 20 wt % anionic surfactant (with no non-ionic ethoxylated C₁₀ Guerbet alcohol surfactant). The liquid laundry detergent including the non-ionic ethoxylated C₁₀ Guerbert alcohol surfactant had around 10% greater foaming volume than the control detergent composition.

Foaming tests were performed by adding a fixed amount of laundry detergent composition in a fixed volume of water and inverting the mixtures in a graduated vessel. The tests were performed three times and an average foam volume taken.

1. A liquid laundry composition comprising:
(i) one or more anionic surfactants; and
(ii) a non-ionic ethoxylated C₁₀ Guerbet alcohol surfactant with a degree of ethoxylation in the range of 1 to 10;
wherein the total amount of anionic surfactant in the composition is in the range of 15 to 25 wt % of the total composition and the weight ratio of the total amount of anionic surfactant to the non-ionic ethoxylated C₁₀ Guerbet alcohol surfactant is in the range of 6:1 to 100:1.

2. A liquid laundry composition according to claim 1, wherein the non-ionic ethoxylated C₁₀ Guerbet alcohol surfactant is selected from the group consisting of non-ionic ethoxylated C₁₀ Guerbet alcohol surfactants with a degree of ethoxylation of 3, 4 or 5.

3. A liquid laundry composition according to claim 2 wherein the non-ionic ethoxylated C₁₀ Guerbet alcohol surfactant is a mixture of different ethoxylated C₁₀ Guerbet alcohol surfactants selected from the group consisting of C₁₀ Guerbet alcohol surfactants with a degree of ethoxylation of 3, 4 and 5.

4. A liquid laundry composition according to claim 1 wherein the non-ionic ethoxylated C₁₀ Guerbet alcohol surfactant has a degree of ethoxylation of 4 or 5.

5. A liquid laundry composition according to claim 1 wherein the composition includes 0.4 to 3.0 wt % of the non-ionic ethoxylated C₁₀ Guerbet alcohol surfactant with a degree of ethoxylation in the range of 1 to 10 based on the total weight of the composition.

6. A liquid laundry composition according to claim 1 wherein the composition includes 16 to 24 wt % of an alkyl benzene sulphonate and/or alcohol ether sulphate based on the total weight of the composition.

7. A liquid laundry composition according to claim 6 wherein the compositions includes 18 to 24 wt % of sodium lauryl ether sulphate (SLES) and/or sodium dodecyl benzene sulphonate (NaLAS).

8. A liquid laundry composition according to claim 1 wherein the weight ratio of the total amount of anionic surfactant to the non-ionic ethoxylated C₁₀ Guerbet alcohol surfactant is in the range of 10:1 to 100:1

9. A liquid laundry composition according to claim 1 wherein the composition further includes one or more additional components selected from the group consisting of: ethoxylated polyethylene imine polymer; polyester soil release polymer; one or more enzymes; enzyme stabiliser; fluorescent agent; bleach catalyst; and perfume.

10. A method comprising:
(a) obtaining a liquid laundry composition including:
(i) one or more anionic surfactants; and
(ii) a non-ionic ethoxylated C₁₀ Guerbet alcohol surfactant with a degree of ethoxylation in the range of 1 to 10;
wherein the total amount of anionic surfactant in the composition is in the range of 15 to 25 wt % of the total composition and the weight ratio of the total amount of anionic surfactant to the non-ionic ethoxylated C₁₀ Guerbet alcohol surfactant is in the range of 6:1 to 100:1; and
(b) laundering textiles with the liquid laundry composition.

11. A method comprising:
(a) obtaining a liquid laundry composition comprising including a non-ionic ethoxylated C10 Guerbet alcohol surfactant with a degree of ethoxylation in the range of 1 to 10; and
(b) washing textiles with the liquid laundry composition, wherein increased foam is provided during the washing step when compared to a composition having a comparable level of anionic surfactant and substantially no non-ionic ethoxylated C10 Guerbet alcohol surfactant with a degree of ethoxylation in the range of 1 to 10
